(19) United States
(12) Patent Application Publication
(10) Pub. No.: US 2006/0213371 A1
(43) Pub. Date: Sep. 28, 2006

(54) Coffee makers

(75) Inventors: Yuhong Zhao, Guangdong Province (CN); Jiang Hu, Guangdong Province (CN)

Correspondence Address: NORRIS, MCLAUGHLIN & MARCUS, P.A., 875 THIRD AVE, 18TH FLOOR, NEW YORK, NY, 10022, US

(73) Assignee: Guangdong Yilong Electrical Appliance Products Co., Foshan City, Guangdong Province (CN)

(21) Appl. No.: 10/566,906

(22) PCT Filed: Aug. 10, 2004
(86) PCT No.: PCT/CN04/00923

§ 371 Date: Feb. 9, 2006

(51) Int. Cl. A47J 31/00

(52) U.S. Cl. 99/279

(57) ABSTRACT

A coffee maker includes a base, a lower portion of a body, an upper portion of the body, a heater, and a water pipe. The base is placed at the bottom of the coffee maker and connected to the lower portion of the body through screws. The base has a supporter by which a coffee cup can be supported. The upper portion of the body comprising a water tank, a lid, an infusing house and a flow distributor, is placed on the top of the body. The coffee maker also includes an actuating mechanism, which allows the upper portion of the body to move up or down. Upon the height of the coffee cup placed at the supporter, by turning a knob of the actuating mechanism, the upper portion of the body may be adjusted to prevent coffee from spaying out from the coffee cup.

### TECHNICAL FIELD OF THE INVENTION

This invention relates to a coffee maker, and more particularly, to a coffee maker having an upper portion that can be moved up and down. This invention belongs to toasting device field.

### BACKGROUND OF THE INVENTION

It is well known that a coffee maker commercially available in the market has a fixed height. However, such a coffee maker fails to satisfy various consumers. Many manufacturers therefore provide some special coffee cups for the conventional coffee maker, but such special coffee cups are limited and always with very common designs. Usually, users like to use their own coffee cups when enjoying coffee.

If a user uses a coffee cup having a relatively short height to take coffee from a conventional coffee maker, coffee will spray out when the cup is almost full. This may cause the coffee maker or a table dirty, and more seriously, cause an electric leakage. Although the user can hold the cup to keep it near the coffee maker while taking coffer, it is really inconvenient.

If a user uses a coffee cup which is too high to be placed on a support of the coffee maker, the user has to tilt the cup to take coffee, and as a result the cup will not be fully filled with coffer. It is inconvenient and troublesome for users to use such a cup.

### SUMMARY OF THE INVENTION

The present invention is to provide a coffee maker having an adjustable height which is convenient for use so as to overcome the above-mentioned drawbacks in the prior art.

In order to fulfill the above, an embodiment of the coffer maker of the present invention comprises: a base; a lower portion of a body; an upper portion of the body; a heater; and a water pipe, the base being placed at a bottom of the coffee maker, the lower portion being connected to the base, the upper portion being located at a top of the body, the base having a supporter for supporting a coffee cup, the upper portion of the body comprising a water tank; a lid; an infusion container; and a flow distributor, a first end of the water pipe being connected to the water tank, a second end of the water pipe being connected to the infusion container, the water pipe being contacted with the heater while contacting parts thereof being made of stainless steel, in which the upper portion of the body and the lower portion of the body are movably connected to each other, and an actuating mechanism is provided at a joint of the upper portion and the lower portion for allowing the upper portion to move up and down.

The object of the present invention can also be achieved by the following technical solutions.

The actuating mechanism comprises a cam; a knob fixedly connected to the cam for driving the cam to turn; and a knob sleeve being in match with the knob and being turnable relative to the knob.

The upper portion of the body may comprise a guiding rod, and the lower portion of the body may comprise a channel, along which the guiding rod can slide up and down.

The cam is in contact with a bottom of the water tank of the upper portion, and when turned in a clockwise direction, the cam can push the bottom of the water tank upwardly, thereby causing the upper portion to move up; and when turned in a counterclockwise direction, the cam no longer supports the bottom of the water tank, thereby causing the upper portion to move down.

The coffee maker of the present invention has the following prominent advantages:

By using the above-mentioned technical solutions, the upper portion of the coffee maker can move up or down through the actuating mechanism, which overcomes the disadvantage that the coffee makers of the prior art have a fixed height. The coffee maker of the present invention can satisfy various users who may have coffee cups with different heights, in no need of controlling the coffee cups by hand in use.

### BRIEF DESCRIPTION OF THE DRAWINGS

FIG. 1 is a perspective view of a coffee maker of the present invention, in which a lower portion of a body of the coffee maker is exploded to show an actuating mechanism thereof;

FIG. 2 is an exploded perspective view showing an actuating mechanism of the present invention;

FIG. 3 is a perspective view showing an upper portion of a body of the present invention; and

FIG. 4 is a perspective view showing a base and a lower portion of a body of the present invention.

### DETAILED DESCRIPTION OF THE INVENTION

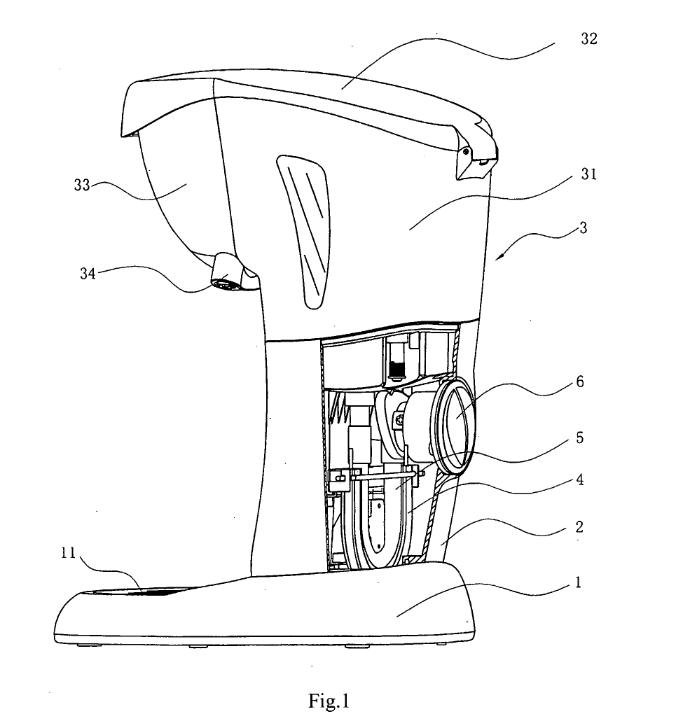

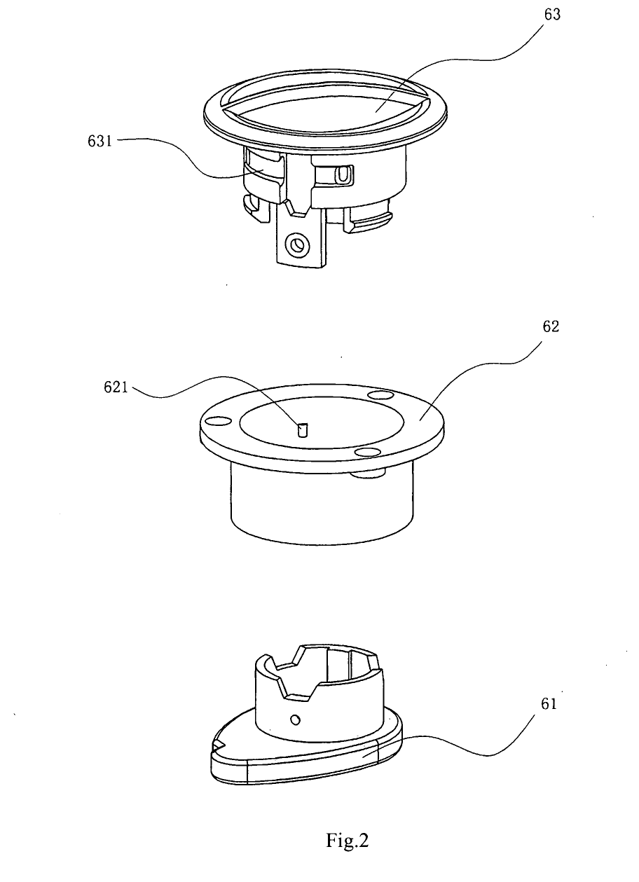

As shown in FIGS. 1 and 2, a coffee maker of the present invention comprises a base 1, a lower portion 2 of a body, an upper portion 3 of the body, a heater 4, and a water pipe 5. The base 1 is placed at a bottom of the coffee maker. The lower portion 2, which is connected to the base 1 through screws, is located at a medium portion of the coffee maker. The upper portion 3 is placed at the top of the body. The base 1 provides a supporter 11 for supporting a coffee cup. The upper portion 3 of the body comprises a water tank 31, a lid 32, an infusion container 33, and a flow distributor 34. One end of the water pipe 5 is connected to the water tank 31, and another end of the water pipe 5 is connected to the infusion container 33. The water pipe 5 is in contact with the heater 4 while contacting parts thereof is made of stainless steel. The coffee maker further comprises an actuating mechanism 6 which is located below the water tank 31 of the upper portion 3 for actuating the upper portion 3 to move up and down. The actuating mechanism 6 comprises a cam 61, a knob sleeve 62 and a knob 63. The cam 61 is fixedly connected to the knob 63 through a screw, so that the cam 61 can be turned while the knob 63 is turned. The knob sleeve 62 is designed to match the knob 63 and is able to turn relative to the knob 63. The cam 61 is in contact with a bottom of the water tank 31 of the upper portion 3. The knob sleeve 62 of the actuating mechanism 6 is fixed in an aperture of the lower portion 2, so that the actuating mechanism 6 is also fixed. The knob sleeve 62 provides a protruded part 621, and a groove 631 is provided by the knob 63 so that the protruding part 621 can relatively slide within the groove 631. The length of the groove 631 is less than a half of the circumference thereof. Since the length of the groove 631 is limited, the relatively sliding distance between the protruding part 621 and the groove 631 is restrained, so that the knob 63 can be turned at a limited angle.

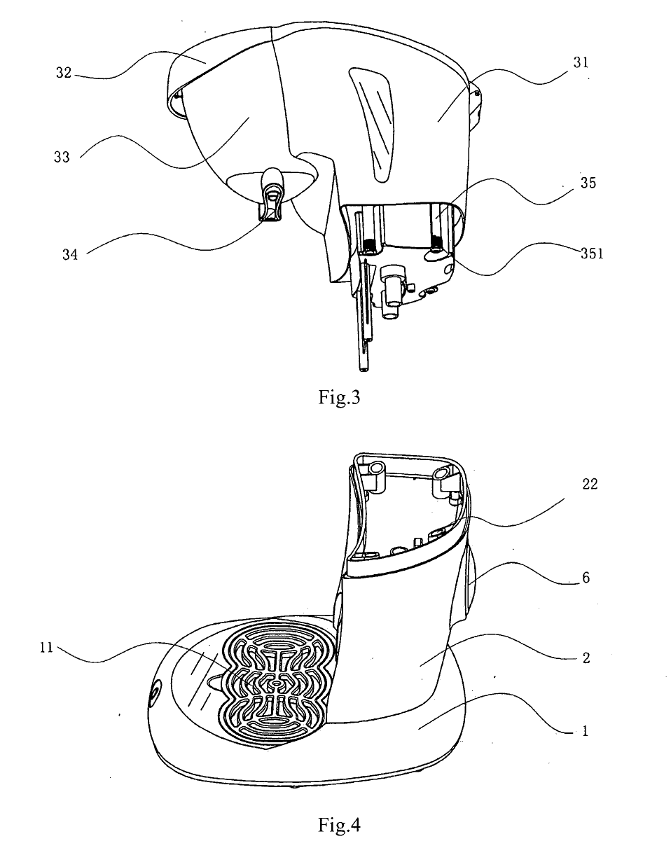

Referring to FIGS. 3 and 4, according to the present invention, the upper portion 3 of the body of the coffee maker comprises a guiding rod 35, and the lower portion 2 comprises a channel 22. The guiding rod 35 is designed to match the channel 22 and the guiding rod 35 can slide along the channel 22. Such a design makes the upper portion 3 of the body of the coffee maker a vertically up and down movement, thereby avoiding it from swaying. The guiding rod 35 is encircled with a spring 351. During the installation, firstly, the guiding rod 35 of the upper portion 3 is inserted into the channel 22 of the lower portion 2; secondly, the spring 351 is disposed to encircle the guiding rod 35; and thirdly, screws are fastened into thread bores of the guiding rod 35 after a gasket is disposed therebetween. In this way, the upper portion 3 and the lower portion 2 are movably connected to each other. The spring 351 is employed to ensure the upper portion 3 can move down normally when turning the knob 63 to lower the upper portion 3, and prevent the upper portion 3 from escaping from the lower portion 2 when turning the knob to heighten the upper portion 3.

According to the present invention, when using the coffee maker, a user may first put a coffee cup on the cup supporter 11, and then adjust the height of the upper portion 3 of the body of the coffee maker according to the height of the coffee cup. For example, if the coffee cup is relatively low, the user may counterclockwise turn the knob 63 to actuate the cam 61 to rotate in a counterclockwise direction, so that the cam 61 no longer supports the bottom of the water tank 31, rendering the guiding rod 35 of the upper portion 3 of the body of the coffee maker to vertically move down along the channel 22 of the lower portion 2. In this way, the upper portion 3 moves downwardly, the height of the coffee maker is reduced, and the flow distributor 34 becomes close to the coffee cup. Coffee is not easy to spray out of the coffee cup. On the other hand, if the coffee cup is relatively tall, the user may clockwise turn the knob 63 to actuate the cam 61 to rotate in a clockwise direction, so that the cam 61 can push the bottom of the water tank 31 upwardly, rendering the guiding rod 35 of the upper portion 3 of the body of the coffee maker vertically move up along the channel 22 of the lower portion 2. In this way, the height of the coffee maker is increased, and the tall coffee cup can be disposed between the flow distributor 34 and the cup supporter 11 in no need of tilting the coffee cup. After adjusting the height of the coffee maker, the coffee maker can be used conveniently.

The present invention employs an actuating mechanism to actuate an upper portion of a body of a coffee maker to move up or down. Depending upon a height of a coffee cup, a height of the coffee maker can be adjusted by a user through turning a knob. The coffee maker of the present invention overcomes the disadvantages that the coffee makers of the prior art have a fixed height, which is convenient for using coffee cups with different heights.

1. A coffee maker, comprising
a base;
a lower portion of a body;
an upper portions of the body;
a heater; and
a water pipe,
the base being located at a bottom of the coffee maker, the lower portion being connected to the base, the upper portion being located at a top of the body, the base having a supporter for supporting a coffee cup, the upper portion of the body comprising a water tank; a pot lid; an infusion container; and a flow distributor, a first end of the water pipe being connected to the water tank and a second end of the water pipe being connected to the infusion container, and the water pipe being in contact with the heater while contacting parts thereof being made of stainless steel,
wherein the upper portion and the lower portion are movably connected to each other, and an actuating mechanism is provided at a joint of the upper portion and the lower portion for allowing the upper portion to move up and down.

2. The coffee maker of claim 1, wherein the actuating mechanism comprises:
a cam;
a knob; and
a knob sleeve,
the cam is located at a bottom of the upper portion and in contact with the bottom of the upper portion, the knob is fixedly connected to the cam to drive the cam to turn, and the knob sleeve matches the knob and is turnable relative to the knob.

3. The coffee maker of claim 2, wherein the actuating mechanism is disposed below the water tank, the knob sleeve is fixed in an aperture of the lower portion to fix the actuating mechanism, and the cam is in contact with a bottom of the water tank.

4. The coffee maker of claim 1, wherein the upper portion comprises a guiding rod, and the lower portion comprises a channel, along which the guiding rod can slide up and down.

5. The coffee maker of claim 2, wherein the knob sleeve provides a protruded part to define the knob turning at a limited degree.

6. The coffee maker of claim 2, wherein the knob provides a groove within which the protruded part can relatively slide.

7. The coffee maker of claim 4, wherein the guiding rod is encircled with a spring.
